(19) United States
(12) Patent Application Publication
(10) Pub. No.: US 2025/0306759 A1
(43) Pub. Date: Oct. 2, 2025

(54) LOSSLESS COMPRESSION OF DATA USING SELF-SIMILARITY

(71) Applicant: Regents of the University of Minnesota, Minneapolis, MN (US)

(72) Inventors: Alireza Khataei, Minneapolis, MN (US); Kiarash Bazargan, Plymouth, MN (US)

(21) Appl. No.: 19/058,823

(22) Filed: Feb. 20, 2025

Related U.S. Application Data
(60) Provisional application No. 63/557,195, filed on Feb. 23, 2024.

(51) Int. Cl. G06F 3/06

(52) U.S. Cl. CPC G06F 3/0608; G06F 3/0655; G06F 3/0679

(57) ABSTRACT

A method, and system, for lossless compression of lookup tables, which uses self-similarities, multilevel compression, and higher-bit compression, and in some claims decomposition, to maximize table size savings. The techniques of this disclosure also use addition and arithmetic right shift with several small lookup tables to retrieve original data during the decoding phase. While lookup tables can hold any arbitrary data, most of the claims in this disclosure will focus on applications of lookup tables in function evaluation. Lookup tables may be used either directly for function evaluation or as parts of other table-based methods. In either case, table compression methods can be used to shrink such tables to reduce their implementation hardware costs.

This application claims the benefit of U.S. Provisional Patent Application No. 63/557,195, filed 23 Feb. 2024, the entire contents of which is incorporated herein by reference.

### GOVERNMENT INTEREST

This invention was made with government support under IIP2016390 awarded by the National Science Foundation. The government has certain rights in the invention.

### TECHNICAL FIELD

The disclosure relates to the compression of tabulated data.

### BACKGROUND

Lookup tables are used in hardware to store arrays of constant values. For instance, complex mathematical functions in hardware are typically implemented through table-based methods such as plain tabulation, piecewise linear approximation, and bipartite or multipartite table methods, which primarily rely on lookup tables to evaluate the functions. Lookup tables are used in both hardware and software systems to store blocks of read-only, predefined data. Such tables may be used in programmable gate arrays (FPGAs), graphics processing units (GPUs), and digital signal processors (DSPs).

### SUMMARY

In general, the disclosure describes a method for lossless compression of lookup tables, which uses self-similarities, multilevel compression, and higher-bit compression, and in some examples decomposition, to maximize table size savings. The techniques of this disclosure also include addition and arithmetic right shift, as well as several small lookup tables, to retrieve original data during the decoding phase. While lookup tables can hold any arbitrary data, most of the examples in this disclosure will focus on applications of lookup tables in function evaluation. Lookup tables may be used either directly for function evaluation or as parts of other table-based methods. In either case, table compression methods can be used to shrink such tables to reduce their implementation hardware costs.

In one example, the disclosure describes a system comprising: processing circuitry operatively coupled to a memory, wherein the memory comprises programming instructions executed by the processing circuitry; the programming instructions comprise instructions for a synthesis algorithm, the synthesis algorithm includes instructions to apply one or more sub-functions to a received table of data, wherein the one or more sub-functions executed by the processing circuitry are configured to compress the received table of data and generate a hardware IP block in the form of a hardware description language for accessing the table of data.

In another example, the disclosure describes a method comprising: receiving, by processing circuitry operatively coupled to a memory; a table of data; applying, by the processing circuitry, one or more sub-functions to the received table of data, wherein the one or more sub-functions executed by the processing circuitry is configured to compress the received table of data; generating, based on the compressed and received table of data, hardware IP block in the form of a hardware description language for accessing the table of data.

In another example, the disclosure describes a non-transitory computer-readable storage medium comprising instructions that, when executed, cause the processing circuitry of a computing device to: receive a table of data; apply one or more sub-functions to a received table of data, wherein the one or more sub-functions executed by the processing circuitry is configured to compress the received table of data; generate, based on the compressed and received table of data, hardware IP block in the form of a hardware description language for accessing the table of data.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example hardware IP block synthesis system configured to generate a hardware IP block based on lossless compression of lookup tables to be used in a computing device.

FIGS. 2A-2E are conceptual diagrams illustrating an example of self-similarities in sub-tables.

FIG. 3 is a conceptual diagram illustrating an example overall architecture of the compression techniques of this disclosure.

FIG. 4 is a flowchart illustrating an example operation of the system of this disclosure.

### DETAILED DESCRIPTION

Lookup tables can hold any arbitrary data. For ease of description, this disclosure describes lookup tables used on function evaluation. Using lookup tables for function evaluation by mapping the input x to output f(x) is an efficient method due to its simplicity of implementation, low computational latency, and high throughput, especially for evaluating compound complex functions, such as 1/[1+exp(−x)], which can be evaluated by a table of precomputed values in hardware instead of performing costly intermediate operations step-by-step. The example techniques should not be considered limited to lookup tables used on function evaluation.

At low resolutions, lookup tables can be directly to implement a function by tabulating the values of all possible inputs. Given a function at the input resolution win and output resolution wₒᵤₜ, the size of the corresponding lookup table would be wₒᵤₜ×2^{win} bits, which grows exponentially as wᵢₙ increases. This direct approach is usually used for evaluating a function at up to 12-bit resolutions.

At higher resolutions, however, simple tabulation of a function is not feasible due to the massive sizes of resulting tables. In such cases, approximate methods may be applied, which sacrifice accuracy for hardware cost savings. Examples of such methods include bipartite table (BT), multipartite table (MT), and piecewise polynomial approximation (PPA) methods. BT and MT decompose the table of a function into smaller tables, called the table of initial values (TIV) and table of offsets (TO), which result in the reduction of hardware costs. PPA methods, however, break a function into sub-functions and approximate them with polynomials whose coefficients are stored in smaller tables. Although all of these methods can simplify the implementation of a function at the expense of accuracy, the techniques still rely on lookup tables to store essential values such as TIV, TO, or tables of coefficients. Lookup tables are also used in other state-of-the-art methods, libraries, and architectures for high-resolution function evaluation. The techniques of this disclosure describe lossless compression of lookup tables, which uses the idea of decomposition, self-similarities, multilevel compression, and higher-bit compression to maximize table size savings.

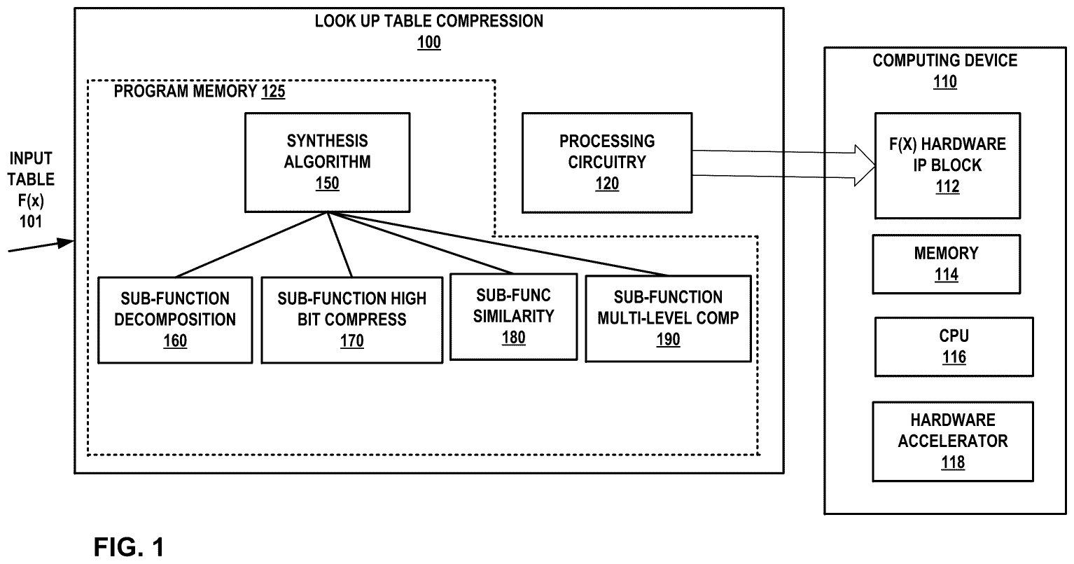

FIG. 1 is a block diagram illustrating an example hardware IP block synthesis system configured to generate a hardware IP block (e.g., in the form of a hardware description language) based on lossless compression of lookup tables used in a computing device. In the example of FIG. 1, look-up table compression system 100 includes processing circuitry 120 that executes the synthesis algorithm 150 residing in its memory 125, procedures for sub-function decomposition 160, sub-function high bit compression 170, sub-function similarity 180, and sub-function multi-level compression 190. Look-up table compression system 100 receives as an input function, F (x), which in some examples may be any arbitrary table of data and generates hardware IP block 112 to implement F (x) to be used in the target computing device 110 along with other compute units such as central processing unit (CPU) 116, other hardware accelerators such as 118, all accessing memory 114. Processing circuitry 120 may generate the hardware IP block 112 in the form of hardware description languages such as register-transfer-level (RTL), Verilog, which describes the behavior of a logic circuit at the gate level, VHDL, and high-level synthesis (HLS).

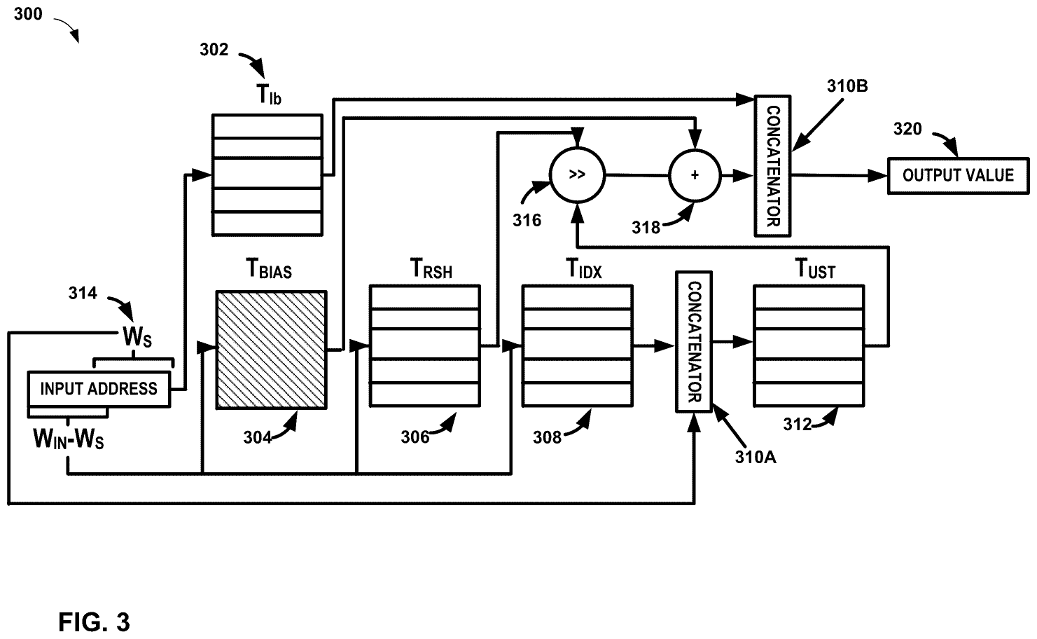

In other examples, the techniques of this disclosure are not just limited to generating hardware IP blocks (e.g., which can be implemented on FPGAs or CPUs/GPUs). Look-up table compression 100 may also generate a series of smaller tables (compressed) that may be placed in the memory of a target CPU or graphics processing unit (GPU) and accessed by the software running on the target CPU or GPU. The access may be done using a series of regular array access instructions such as bias[i], rsh[i], and similar instructions, and put together through a series of additions and shift operations, similar to the operations described in FIG. 3 below. The differences between FIG. 3 and FIG. 1 may include the implementation with dedicated hardware IP units. The table compression may also be valuable for tables used in software. In the case of software implementation, there may not be any Block 112. Instead, the table may be housed in memory 114.

Processing circuitry 120, executing the programming instructions stored in sub-function decomposition 160, may decompose a table T into two tables T_{bias} and Tₛₜ. The input address of Tₛₜ is the same as the input address of T, but the input address of T_{bias} may be fed by the (wᵢₙ−wₛ) higher bits of the input address of T. Tₛₜ holds local variations which may require a smaller bit width, especially if the function is smooth with small gradients. The bias value from T_{bias} corresponding to an entry in the Tₛₜ table may be added to the entry in the Tₛₜ table to get the value of the original table entry. In summary, the table T_{bias} has the same output bit width as the original table T, but it has fewer elements. In contrast, table Tₛₜ has the same number of elements as the original table T, but it has less output bit width.

At low resolutions, computing device 110 may directly use lookup tables to implement a function by tabulating the values of all possible inputs. The direct approach may be useful for evaluating a function at up to 12-bit resolutions.

At higher resolutions, however, simple tabulation of a function may not feasible due to the massive sizes of resulting tables. Also, compression techniques may be more efficient if there are small differences between consecutive values in a table, e.g., when the values in a table change continuously and with small gradients. On the other hand, there are two issues in the compression of tables with more discrete values that show large differences between consecutive elements. The first issue is the increase of wₛₜ in Tₛₜ after decomposition, which may negatively impact the final table size savings. This is because there are larger differences between consecutive values in T, and therefore, result in higher local variations. As a result, the values in Tₛₜ, which stores the local variations, require a wider bit width wₛₜ. The second issue is with self-similarities. Since the values of sub-tables are larger, it is likely harder to find similarities among the sub-tables. Therefore, the number of unique sub-tables increases, which in turn results in less table size savings.

Therefore, processing circuitry 120 executing synthesis algorithm 150, and sub-function higher bit compression 170 may split the values of T into higher and lower bits before performing decomposition 160 and self-similarity measures 180. Processing circuitry 120 may divide values of T into wₗ lower bits and wₒᵤₜ-wₗ higher bits and store the values into two separate tables T_{lb} and T_{hb}, respectively. Table T_{lb} undergoes no compression, but T_{hb} is compressed by using decomposition 160 and self-similarities 180. Processing circuitry 120 may divide the tables into tables T_{lb} and T_{hb}, effectively reducing the distances between consecutive values of T by considering higher bits. Therefore, processing circuitry 120 may cause local variations to become lower, which potentially results in more table size savings after using decomposition 160 and self-similarity 180 techniques.

Processing circuitry 120 may further compress T_{bias} by executing the programming instructions with multilevel compression 190. Multilevel compression performs decomposition 160, self-similarity 180, and high bit compression 170 to the T_{bias} matrix. As a result, processing circuitry 120 replaces T_{bias} itself by another set of T_{lb}, Tᵤₛₜ, T_{idx}, Tᵣₛₕ, and T_{bias} which may be alternatively referred to as “sub-tables” or “compressed sub-tables” throughout. Processing circuitry 120 may apply multilevel compression 190 once, twice or any number of times. Note that plotting the values of T and T_{bias} will result in two outputs with a similar shape because T_{bias} is the same as table T downsampled by a factor of 2\hat{ }(wᵢₙ−wₛ). Although T_{bias} has a coarser granularity than T, this granularity can be resolved by splitting the values of T_{bias} into higher and lower bits, as described for higher bit compression 170. In some examples, one or more of the compressed sub-tables are derived from a table of data.

Examples of processing circuitry 120 may include any one or more of a microcontroller (MCU), e.g. a computer on a single integrated circuit containing a processor core, memory, and programmable input/output peripherals, a microprocessor (μP), e.g. a central processing unit (CPU) on a single integrated circuit (IC), a controller, a digital signal processor (DSP), an application specific integrated circuit (ASIC), a field-programmable gate array (FPGA), a system on chip (SoC) or equivalent discrete or integrated logic circuitry. A processor may be integrated circuitry, i.e., integrated processing circuitry, and that the integrated processing circuitry may be realized as fixed hardware processing circuitry, programmable processing circuitry and/or a combination of both fixed and programmable processing circuitry. Accordingly, the terms “processing circuitry,” “processor” or “controller,” as used herein, may refer to any one or more of the foregoing structures or any other structure operable to perform techniques described herein.

Examples of memory 125 may include any type of computer-readable storage media. Some examples may include random access memory (RAM), read only memory (ROM), programmable read only memory (PROM), erasable programmable read only memory (EPROM), one-time programmable (OTP) memory, electronically erasable programmable read only memory (EEPROM), flash memory, or another type of volatile or non-volatile memory device. In some examples the computer readable storage media may store instructions that cause the processing circuitry to execute the functions described herein. In some examples, the computer readable storage media may store data, such as configuration information, temporary values, and other types of data used to perform the functions of this disclosure. In some examples, memory and/or IP block 112 may store one or more compressed sub-tables.

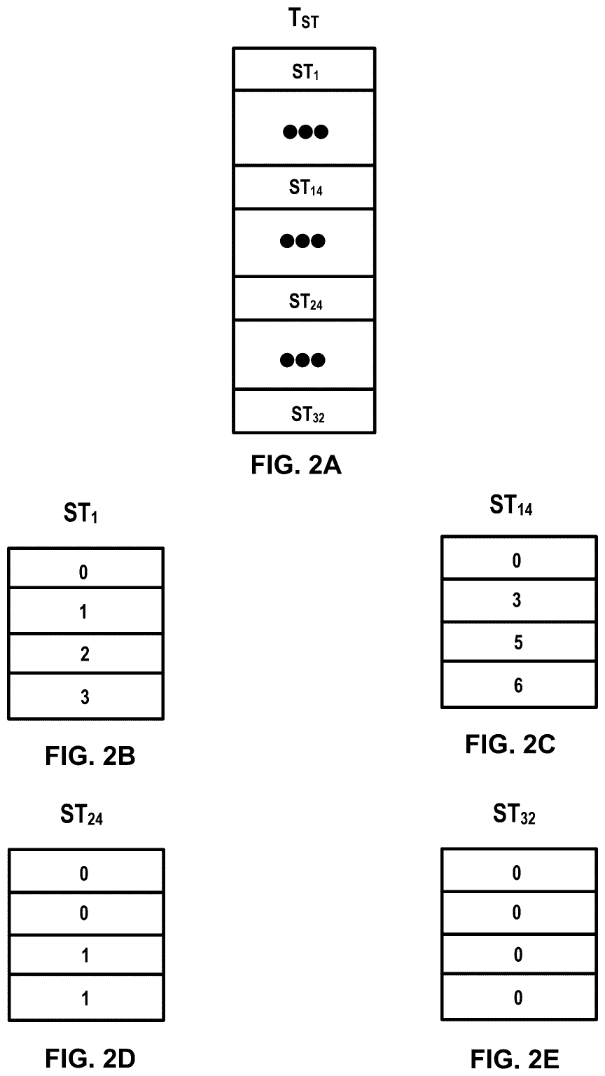

FIGS. 2A-2E are conceptual diagrams illustrating an example of self-similarities in sub-tables. In the example of FIGS. 2A-2E, a system may break Tₛₜ of FIG. 2A, and the sub-tables of FIGS. 2B, 2C, 2D, and 2E into sub-tables using decomposition applied to an original table T, described above in relation to sub-function decomposition 160 of FIG. 1. For example, for a table T with 2^{win} elements of wₒᵤₜ bits, a system may split table Tinto n=2^{win-ws} sub-tables, where 0<wₛ<wᵢₙ. Next, the system may store the minimum value of each sub-table as an element in a bias table T_{bias} (not shown). Additionally, the system may subtract the minimum value of each sub-table from all the values in the corresponding sub-table and the resulting values are stored in Tₛₜ. The bias table, T_{bias} may have 2^{win-ws} elements of w_{bias} bits, where w_{bias} is usually the same as wₒᵤₜ. Whereas Tₛₜ has 2^{win} elements of wₛₜ bits, where wₛₜ is less than wₒᵤₜ. This is because Tₛₜ holds local variations which usually require a smaller bit width. In summary, the table T_{bias} may have the same output bit width as the original table T, but it has fewer elements. In contrast, table Tₛₜ has the same number of elements as the original table T, but it has a smaller output bit width. The tables have the following total number of bits:

$$Size ( T ) = {2}^{win} \times {w}_{out} \\ Size ( {T}_{bias} ) = {2}^{{win}^{-} ws} \times {w}_{bias} \\ Size ( Tst ) = {2}^{win} \times {w}_{st}$$

The final size ratio obtained by table decomposition is as follows

$$\begin{matrix}SizeRatio = [ Size ( {T}_{bias} ) + Size ( {T}_{s t} ) ] / Size ( T ) \\ = [ {2}^{win - ws} \times {w}_{bias} + {2}^{win} \times {w}_{st} ] / ( {2}^{win} \times {w}_{out} ) \\ = {2}^{- ws} + {w}_{st} / {w}_{out}\end{matrix}$$

The final size ratio after decomposition depends on two terms: 2^{-ws} and wₛₜ/wₒᵤₜ. The parameter ws can be set to any value between 0 and wᵢₙ. Increasing ws decreases the first term 2^{-ws}, yet it increases the second term wₛₜ/wₒᵤₜ. This is because increasing ws results in sub-tables with more elements, which might have larger local variations, that require greater bit width wₛₜ.

After decomposition, a system may replace the original table T by T_{bias} and Tₛₜ. The input address of Tₛₜ is the same as the input address of T, but the input address of T_{bias} is fed by the (wᵢₙ-wₛ) higher bits of the input address of T. Finally, an adder retrieves the values of the original table T by adding the output values of Tₛₜ and T_{bias}.

The result of the decomposition is table Tₛₜ, which may include one or more other sub-tables as shown in FIGS. 2A-2E. Applying the self-similarity approach of this disclosure may compress table Tₛₜ still further.

Tₛₜ holds the values of n sub-tables STi, where i∈{1, 2, . . . , n}. However, the values of many of these sub-tables are similar. Similar sub-tables refer to the sub-tables whose values are either identical or can get identical through the arithmetic right shift operation. FIG. 2A shows an example of Tₛₜ which contains 32 sub-tables of four elements. Therefore, Tₛₜ has 128 elements in total. The values of four sub-tables ST1, ST14, ST24, and ST32 are shown separately. If processing circuitry 120 shifts the values of ST14 to the right by one bit, the resulting table is the same as ST1. Additionally, if processing circuitry 120 shifts the values of ST14 to the right by 2 or 3 bits, the values are the same as those in ST24 or ST32, respectively. In other words, ST14 may generate ST1, ST24, and ST32 using the right shift operation. As a result, instead of storing four different sub-tables, the processing circuitry may store only ST14 as a unique sub-table, through which the processing circuitry may retrieve the other sub-tables.

In addition to ST14, ST1 may also generate ST24 and ST32, but this time by processing circuitry 120 shifting to the right by 1 and 2 bits, respectively. Furthermore, the processing circuitry may use ST24 to generate ST32 by shifting ST24 to the right by 1 bit. However, among these 4 sub-tables, considering ST14 as the unique, or primary, sub-table may the best choice since ST14 may be used to generate the other secondary sub-tables. Therefore, the final goal of this phase may be to find the minimum set of unique sub-tables in Tₛₜ that can generate the secondary sub-tables.

Using the self-similarity matrix, processing circuitry 120 may identify similarities among all sub-tables in Tₛₜ. As discussed above, Tₛₜ consists of n=2^{win-ws} sub-tables, and each sub-table consists of 2^{w}^{ₛ} elements. To measure similarities, processing circuitry 120 may need an n x n Boolean matrix, which is called a similarity matrix (SM). Each entry of this similarity matrix specifies whether the two sub-tables are similar or not. That is, an entry in the similarity matrix of sᵢⱼ is 1 if the sub-table STᵢ may generate STⱼ. The similarity matrix may not be symmetric since if STi can generate STj through right shifting, the opposite is not necessarily true. The following is the definition of the n×n similarity matrix, SM:

sm_{1, 1} sm_{1, 2} . . . sm_{1, n}
sm_{2, 1} sm_{2, 2} . . . sm_{2, n}
sm_{n, 1} sm_{n, 2} . . . sm_{n, n}

$$smi , j = 1 ⇔ ∃ t ∈ N : ∀ m ∈ N ( m < {2}^{ws} ) , rsht \{ STi [ m ] \} = STj [ m ]$$

where rsht denotes an arithmetic right shift by t bits.
In some examples, processing circuitry 120 may compare received tables of data from a decomposition sub-function. Processing circuitry 120 may be configured with programming instructions that include programming instructions that cause processing circuitry 120 to compare the received tables of data from the decomposition sub-function. Processing circuitry 120 may determine whether one or more secondary tables are generable by a primary table, where determining whether the one or more secondary tables are generable includes determining whether the one more secondary tables are capable of being generated or produced by processing circuitry 120 from the primary table. Processing circuitry 120 may process a subset of data from a table of data that includes a self-similarities subset of data (e.g., a sub-function similarity, such as sub-function similarity 180 of FIG. 1, to find similarities among sub-tables or sub-functions) that includes programming instructions to compare received tables of data from a decomposition subset of data and determine whether one or more secondary tables are generable by a primary table. For instance, processing circuitry 120 may compress table T_{hb} by using the self-similarity subset of data. Processing circuitry 120 may execute programming instructions that further include programming instructions to apply a higher bit compression subset of data, where applying a higher bit compression subset of data includes first splitting the received table into a first table of lower bits and second table of higher bits, then applying the decomposition subset of data to the first table of lower bits

After identifying similar sub-tables, processing circuitry 120 may identify a unique set of sub-tables that can generate the other sub-tables to retrieve the original Tₛₜ. Unique sub-tables are named UST, and processing circuitry 120 may store this set of unique, or primary sub-tables all stored in a new single table, called Tᵤₛₜ. Furthermore, processing circuitry 120 may use two new tables of n elements, called T_{idx} and Tᵣₛₕ, to retrieve the original table Tₛₜ through Tᵤₛₜ. The value of the ith element in T_{idx} shows the index of the unique sub-function that can generate STᵢ, and the value of the ith element in Tᵣₛₕ shows the number of right bit shifts to be performed on the values of the corresponding unique sub-table to retrieve STi. For instance, if T_{idx}[5]=3 and Tᵣₛₕ[5]=2, then processing circuitry 120 may retrieve ST₅ by UST₃ after right shifting the values of UST₃ by 2 bits.

To find unique sub-tables, processing circuitry 120 may determine a similarity vector obtained based on the similarity matrix. In the similarity vector, the jth entry specifies how many sub-tables can be generated using the jth sub-table. Processing circuitry 120 may create the vector by adding the values in each column in the similarity matrix as follows.

$$SimilarityVector = [ sv 1 , sv 2 , … , svn ] \\ {sv}_{j} = {\sum }_{i} {sm}_{i j}$$

The index of the element in the similarity vector with the maximum value determines the first unique sub-table. In other words, if svᵢ is the element with the maximum value, STᵢ may be considered as the first unique sub-table UST₁, and its values are stored in Tᵤₛₜ. Processing circuitry 120 may then traverse through the ith column of the similarity matrix to see which sub-tables can be generated through STᵢ. If STᵢ can generate STⱼ through right shifting by t bits, then processing circuitry 120 sets jth element of T_{idx} and Tᵣₛₕ to 1 and t, respectively. After finding the first unique sub-table, processing circuitry 120 updates the similarity matrix and similarity vector. Therefore, the processing circuitry sets the ith row and column of the similarity matrix to 0. Additionally, if STᵢ can generate STⱼ, the jth row and column of the similarity matrix are set to 0 as well. Processing circuitry 120 recalculates the elements of the similarity vector based on the updated similarity matrix.

Processing circuitry 120 repeats the above process again and again until all the entries of the similarity matrix are 0's. In each iteration, processing circuitry 120 may identify a new unique sub-table. As one example, if the process takes k iterations to finish, the result will be k unique sub-tables USTᵢ, where i∈{1, 2, . . . , k} and k≤n. Processing circuitry 120 stores these unique sub-tables in Tᵤₛₜ.

As a result, processing circuitry 120 replaces Tₛₜ by Tᵤₛₜ, T_{idx}, and Tᵣₛₕ. In contrast to Tₛₜ, which contains n sub-tables, Tᵤₛₜ contains k unique sub-tables, where k is often far less than n. It means that many secondary sub-tables may be generated using a few unique sub-tables. Therefore, the self-similarities process may achieve significant table size reductions. However, when calculating the overall memory space reduction, the size of T_{idx} and Tᵣₛₕ should also be considered. In summary, the size of each table and the size ratio are as follows.

$$Size ( Tst ) = n \times {2}^{w s} \times {w}_{s t} \\ Size ( Tust ) = k \times {2}^{w s} \times {w}_{s t} \\ Size ( Tidx ) = n \times {w}_{idx} \\ Size ( Trsh ) = n \times {w}_{rsh} \\ \begin{matrix}SizeRatio = [ Size ( Tust ) + Size ( Tidx ) + Size ( Trsh ) ] / Size ( Tst ) \\ = [ {w}_{idx} + {w}_{rsh} ] / ( {2}^{ws} \times {w}_{st} ) + k / n\end{matrix}$$

where w_{idx} and wᵣₛₕ are the bit width of the values in T_{idx} and Tᵣₛₕ, respectively. In the examples of FIGS. 2A-2E, the processing circuitry may force wᵣₛₕ to be 2, which means that during the self-similarity search process, we limit the value of t in the similarity matrix, SM, 1 to the range of [0,3]. The value of w_{idx} depends on the number of unique sub-tables and is equal to floor (log 2(k−1))+1.

FIG. 3 is a conceptual diagram illustrating an example overall architecture of the compression techniques of this disclosure. As described above in relation to FIG. 1, function 300 is an example of hardware IP block 112 that may evaluate a function as part of computing device 110. The techniques of this disclosure may receive an input table T, and through its analysis and optimization in 150, determine two parameters wₛ and wₗ and replace table T by five other tables, shown in FIG. 3, e.g., T-lower bits (T_{lb} 302), T-unique sub tables (Tᵤₛₜ 312), index table (T_{idx} 308), T-right shift values (Tᵣₛₕ 306), and table of biases (T_{bias} 304), as described above in relation to FIGS. 2A-2E. The value of the ith element in T_{idx} shows the index of the unique sub-function that can generate STᵢ. In some examples, T_{lb} includes lower bits of the output data, Tᵤₛₜ includes unique sub-tables of the table of data, T_{idx} includes indices, Tᵣₛₕ includes right shift values, or T_{bias} includes a minimum value to be added as part of the output data. Furthermore, processing circuitry and/or other components/process may derive T_{bias} from a table of data by finding a minimum value from each subset of data.

Processing circuitry 120, e.g., as shown in computing device 100 of FIG. 1, may break the input address to lower bits, lb, and higher bits, hb, and store the lb at T_{lb} 302. Concatenator 310B may concatenate the removed lb data to generate or form output data 320. Similarly, concatenator 310A may concatenate address wₛ 314 to the associated value from T_{idx} 308 to select the unique sub table from Tᵤₛₜ 312. Processing circuitry 120 may receive address as a value for the input for function 300 and/or as an address for the output value of data table replaced by function 300 (e.g., a pre-scaling circuit may process an input and generate address ws 314 for input to function 300). Right shift 316 may shift the selected number of bits from Tᵣₛₕ 306 based at least in part on the input address, e.g., wᵢₙ−wₛ. For example, processing circuitry 120 may perform a right shift on a selected number of bits of the sub-table Tᵣₛₕ based in part on the upper bits of the input address. Adder 318 may add the selected entry from T_{bias} 304 for the final output value 320. In some examples, adder 318 adds an output value of a table T_{bias} and an output value of a right shift or Tᵤₛₜ output. In some examples, function 300 may be implemented as a circuit that includes circuitry configured to retrieve values from compressed sub-tables and generate output based on the retrieved values. For instance, function 300 may include an input circuit (not illustrated) configured to receive an input address for a table of data (e.g., wₛ 314).

Processing circuitry 120 may determine the parameters wₛ and wₗ for each specific input table T. As described above in relation to FIGS. 2A-2E, the parameter wₛ 314 can be set to any value between 0 and wᵢₙ. In some examples, digital system 100 may iteratively select wₛ and wₗ and may evaluate parameter selection based on the total sizes of all generated tables. While the runtime of this procedure depends on the initial size of a lookup table, in many examples the run time may be in the range of ten seconds or less.

As described above in relation to FIGS. 1 and 2, the use of the compression techniques of this disclosure may significantly compress lookup tables used for function evaluation. However, the techniques of this disclosure are not limited to math functions and may be used as a general lossless compression scheme to store data either on-chip or off-chip using less memory resources. The benefit of these techniques is that while the individual or combined techniques compress data, the techniques do not require complex and costly decoders to decompress data in hardware, e.g., in F (x) hardware IP block 112, described above in relation to FIG. 1. In other words, CPU 116 may recover original data using hardware-efficient decoders, that can be easily pipelined to maximize throughput.

Moreover, these techniques may be extended to multidimensional lookup tables. For instance, a system may compress a two-dimensional (2D) table by decomposing the table into smaller 2D sub-tables and finding unique sets of sub-tables that can recover the original table through simple transformations. A system may also apply multilevel compression and higher-bit compression techniques while executing the synthesis algorithm as well. Therefore, in some examples, any type of data, e.g., image data, may be more effectively compressed using multidimensional lookup tables, e.g., as described above in relation to multi-level compression 190 of FIG. 1. While described in the context of a system, in some examples processing circuitry 120 may perform one or more of the described actions.

As discussed above, a low-resolution function at up to 12 bits may also be evaluated directly by lookup tables containing the values of the function for all possible input values. Such tables may be compressed using the lossless compression techniques of this disclosure, which may reduce hardware costs with no accuracy loss. Using such cost-effective elements results in generating hardware implementation, as shown in FIG. 1, and may result in low IC area use and deliver high throughput.

Processing circuitry 120, as described in relation to FIG. 1, may execute the below pseudo-code, illustrating an example of at least some of the techniques of this disclosure. The pseudo-code below may include examples of synthesis algorithm 150 executed by processing circuitry 120, e.g., sub-function decomposition 160 and sub-function similarity 180. The outermost optimization loop of 150 may analyze and optimize different values of wₗ and wₛ are not shown here.

| | |
|---|---|
| 1 | Input: T, wₗ, and wₛ |
| 2 | Outputs: T_{lb}, Tᵤₛₜ, T_{bias}, T_{idx}, and Tᵣₛₕ |
| 3 | T_{lb} [:] ←bitand (T [:], 2^{wlb} − 1) |
| 4 | T_{hb} [:] ←rsh(T [:],w_{lb}) |
| 5 | wᵢₙ ←bitwidth(length(T) − 1) |
| 6 | wₒᵤₜ ←bitwidth(max (T)) |
| 7 | n ← 2^{win-ws} |
| 8 | # Compression of Thb Using Decomposition |
| 9 | for i = 1 to n do |
| 10 | ST [:] ←T_{hb} [(i − 1) × 2^{ws} + 1 : i × 2^{ws} ] |
| 11 | Tₛₜ [(i − 1) × 2^{ws} + 1 : i × 2^{ws}] ←ST [:] −min(ST [:]) |
| 12 | T_{bias} [i] ←min(ST [:]) |
| 13 | end |
| 14 | # Compression of Tₛₜ Using Self-Similarities |
| 15 | SimilarityMatrix [:] [:] ←zeros (n, n) |
| 16 | RighShiftMatrix [:] [:] ←zeros (n, n) |
| 17 | for i = 1 to n do |
| 18 | STᵢ ← Tₛₜ [(i − 1) × 2^{ws} + 1 : i × 2^{ws}] |
| 19 | for j = 1 to n do |
| 20 | STⱼ ← Tₛₜ [( j − 1) × 2^{ws} + 1 : j × 2^{ws}] |
| 21 | for t = 0 to 3 do |
| 22 | if rsh(STi [:], t ) == STj [:] then |
| 23 | SimilarityMatrix [i] [ j ] ← 1 |
| 24 | RighShiftMatrix [i] [ j ] ←t |
| 25 | break |
| 26 | end |
| 27 | end |
| 28 | end |
| 29 | end |
| 30 | k ← 0 |
| 31 | SimilarityVector [:] ←zeros (1, n) |
| 32 | while SimilarityMatrix [:] [:] ! = zeros (n, n) do |
| 33 | k ←k + 1 # increment the number of unique sub-tables |
| 34 | SimilarityVector [:] ← Σᵢ SimilarityMatrix [i] [:] |
| 35 | idx ← arg maxi SimilarityVector [i] |
| 36 | UST [:] ← Tₛₜ [(idx − 1) × 2^{ws} + 1 : idx × 2^{ws}] |
| 37 | Tᵤₛₜ [(k − 1) × 2^{ws} + 1 : k × 2^{ws}] ←UST [:] |
| 38 | T_{idx} [idx] ←k |
| 39 | SimilarityMatrix [idx] [idx] ← 0 |
| 40 | # reference similar sub-tables to the kth unique sub-table |
| 41 | for i = 1 to n do |
| 42 | if SimilarityMatrix [i] [idx] == 1 then |
| 43 | T_{idx} [i] ←k |
| 44 | Tᵣₛₕ ← RighShiftMatrix [i] [idx] |
| 45 | SimilarityMatrix [i] [:] ←zeros (1, n) |
| 46 | SimilarityMatrix [:] [i] ←zeros (n, 1) |
| 47 | end |
| 48 | end |
| 49 | SimilarityMatrix [idx] [:] ←zeros (1, n) |
| 50 | end |

Average results from using the techniques of this disclosure compared to other techniques may result in a five times better final size ratio, as well as a four times improved throughput per slice (TPS) ratio when compared, e.g., to the Plain Table technique.

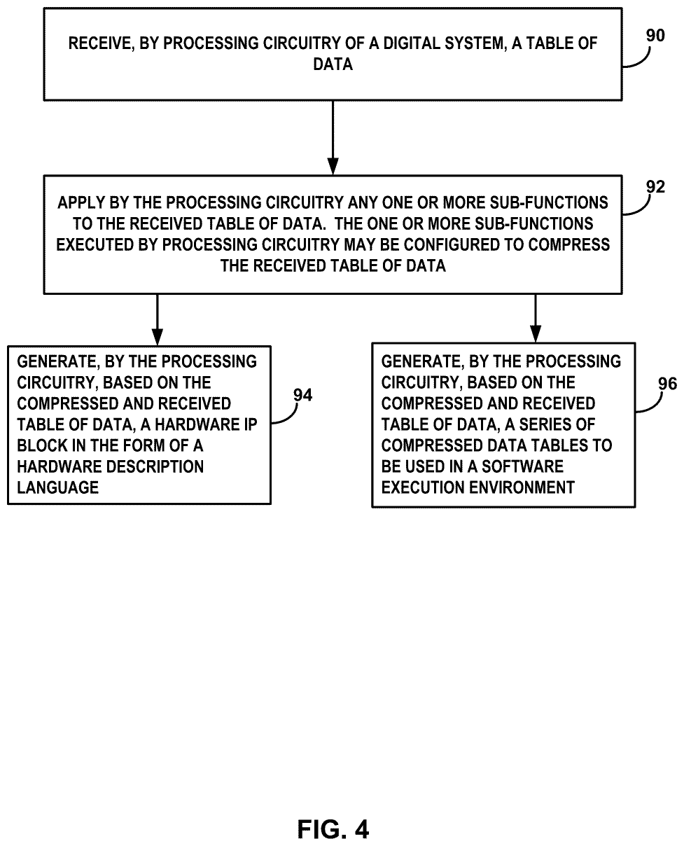

FIG. 4 is a flowchart illustrating an example operation of the system of this disclosure. The blocks of FIG. 4 will be described in terms of FIG. 1, unless otherwise noted.

Processing circuitry 120 of system 100, operatively coupled to program memory 125, receives a table of data (90). The table may represent a function, F (x), or may be any table of data.

Processing circuitry 120 applies any one or more sub-functions to the received table of data. The one or more sub-functions executed by processing circuitry 120 may be configured to compress the received table of data 101 (the process denoted in Box 92). As shown in FIG. 1, synthesis algorithm 150 may include any of sub-function decomposition 160, sub-function high bit compression 170, sub-function similarity 180, and sub-function multi-level compression 190.

Processing circuitry 120 generates, based on the compressed and received table of data, a hardware IP block in the form of a hardware description language (94). The processing circuitry 120 executing synthesis algorithm 150 will generate hardware description in RTL, HLS or other hardware programming languages, that describe the adder 318, shifter 316, all the corresponding tables 302, 304, 306, 308, and 312, and the connections between these blocks and the control logic managing their operations. In such a case, the functional blocks 316, 318, 310A, and 310B will appear in 112. The data tables 203, 304, 306, 308 and 312 can appear either in 112 or in 114.

In another embodiment of system 100, the processing circuitry 120 targets a purely software implementation. In such a case, no hardware IP block 112 will be generated. Processing circuitry 120 executing synthesis algorithm 150 will generate all relevant tables 302, 304, 306, 308, and 312, which will be placed in memory 114. Addition operation 318, shift operation 316, and the separation of the input address into wᵢₙ−wₛ and wₛ bits, data retrieval from relevant tables, and concatenation operations 310A and 310B are all performed by the target system CPU 116. Processing circuitry 120 may 120 concatenate lower bits of the input address with retrieved values from the compressed sub-tables as part of generating output data.

The techniques of this disclosure may also be described in the following examples.

Example 1A. A system comprising: processing circuitry operatively coupled to a memory, wherein the memory comprises programming instructions executed by the processing circuitry; the programming instructions comprise instructions for a synthesis algorithm, the synthesis algorithm includes instructions to apply one or more sub-functions to a received table of data, wherein the one or more sub-functions executed by the processing circuitry are configured to compress the received table of data and generate a hardware IP block in the form of a hardware description language for accessing the table of data.

Example 2A. The system of example 1A, wherein the instructions to apply the sub-function comprise instructions to apply a decomposition sub-function configured to receive the table of data and break the table of data into sub-tables, wherein the processing circuitry is configured to: store a minimum value of each sub-table as an element in a table T_{bias}; and subtract the minimum value from all values in each corresponding sub-table and store the resulting values in table Tₛₜ.

Example A3. The system of example 2A, wherein the programming instructions further comprise programming instructions to apply a self-similarities sub-function that includes programming instructions to compare the received tables of data from the decomposition sub-function and determine whether one or more secondary tables are generatable by a primary table.

Example 4A. The system of example 3A, wherein to apply a higher bit compression sub-function comprises to first split the received table into a first table of lower bits and second table of higher bits, then apply the decomposition sub-function to the first table of lower bits.

Example 5A. The system of example 4A, wherein to apply a multilevel compression sub-function comprises to first apply decomposition sub-function, resulting in T_{bias} and Tₛₜ, then applying the decomposition sub-function, the self-similarity sub-function and high bit compression sub-function one or more times to the resulting T_{bias} matrix, wherein T_{bias} is replaced by another set of T_{lb}, Tᵤₛₜ, T_{idx}, Tᵣₛₕ, and T_{bias}.

Example 6A. A method comprising: receiving, by processing circuitry operatively coupled to a memory; a table of data; applying, by the processing circuitry, one or more sub-functions to the received table of data, wherein the one or more sub-functions executed by the processing circuitry is configured to compress the received table of data; generating, based on the compressed and received table of data, hardware IP block in the form of a hardware description language for accessing the table of data.

Example 7A. The method of example 6A, wherein applying the one or more sub-functions comprises applying, by the processing circuitry, a decomposition sub-function configured to receive the table of data and break the table of data into sub-tables; the method further comprising: storing a minimum value of each sub-table as an element in a table T_{bias}; and subtracting the minimum value from all values in each corresponding sub-table and store the resulting values in table Tₛₜ.

Example 8A. The method of example 7A, wherein applying the one or more sub-functions comprises applying, by the processing circuitry a self-similarities sub-function, wherein the self-similarities sub-function comprises comparing, by the processing circuitry, the received tables of data from the decomposition sub-function and determine whether one or more secondary tables may be generated by a primary table.

Example 9A. The method of example 8A, wherein applying a higher bit compression sub-function comprises: first, splitting the received table into a first table of lower bits and second table of higher bits, then applying the decomposition sub-function to the first table of lower bits.

Example 10A. The method of example 9A, wherein applying, by the processing circuitry, a multilevel compression sub-function comprises: first applying, by the processing circuitry, the decomposition sub-function, resulting in T_{bias} and Tₛₜ, then applying, by the processing circuitry, the decomposition sub-function, the self-similarity sub-function and high bit compression sub-function one or more times to the resulting T_{bias} matrix, wherein, for each iteration, T_{bias} is replaced by another set of T_{wb}, Tᵤₛₜ, T_{idx}, Tᵣₛₕ, and T_{bias}.

Example 11A. A non-transitory computer-readable storage medium comprising instructions that, when executed, cause processing circuitry of a computing device to: receive a table of data; apply one or more sub-functions to a received table of data, wherein the one or more sub-functions executed by the processing circuitry is configured to compress the received table of data; generate, based on the compressed and received table of data, hardware IP block in the form of a hardware description language for accessing the table of data.

Example 12A. The non-transitory computer-readable storage medium of example 11A, wherein the instructions to apply the sub-function comprise instructions to apply, by the processing circuitry, a decomposition sub-function configured to: receive the table of data and break the table of data into sub-tables; store a minimum value of each sub-table as an element in a table T_{bias}; subtract the minimum value from all values in each corresponding sub-table and store the resulting values in table Tₛₜ.

Example 13A. The non-transitory computer-readable storage medium of example 12A, wherein the instructions further cause the processing circuitry to apply a self-similarities sub-function that includes programming instructions to compare the received tables of data from the decomposition sub-function and determine whether one or more secondary tables may be generated by a primary table.

Example 14A. The non-transitory computer-readable storage medium of example 13A, wherein the instructions cause the processing circuitry to: apply a higher bit compression sub-function wherein to apply the higher bit compression sub-function comprises: first, split the received table into a first table of lower bits and second table of higher bits, then apply the decomposition sub-function to the first table of lower bits.

Example 15A. The non-transitory computer-readable storage medium of example 14, wherein the instructions cause the processing circuitry to apply a multilevel compression sub-function comprises: first to apply, by the processing circuitry, the decomposition sub-function, resulting in T_{bias} and Tₛₜ, then apply, by the processing circuitry, the decomposition sub-function, the self-similarity sub-function and high bit compression sub-function one or more times to the resulting T_{bias} matrix, wherein, for each iteration, T_{bias} is replaced by another set of T_{lb}, Tᵤₛₜ, T_{idx}, Tᵣₛₕ, and T_{bias}.

Example: 1B. A system comprising: processing circuitry operatively coupled to a memory, wherein the memory comprises programming instructions executed by the processing circuitry; the programming instructions comprise instructions for a synthesis algorithm, the synthesis algorithm includes instructions to apply one or more sub-functions to a received table of data, wherein the one or more sub-functions executed by the processing circuitry are configured to compress the received table of data and store the compressed table of data in memory.

Example 2B. The system of claim 1B, wherein the one or more sub-functions executed by the processing circuitry are configured to compress the received table of data and generate a hardware IP block in the form of a hardware description language for accessing the table of data.

Example 3B. The system of claim 1B, wherein to store the compressed table of data in memory comprises generating a series of memory blocks to be placed in memory of a processing unit accessed by software running on the processing unit using a series of array access instructions.

Example 4B. The system of claim 1B, wherein the memory is located on chip.

Example 5B. The system of claim 1B, wherein the memory is located off-chip.

Example 6B. The system of claim 1B, wherein the memory is located off-chip as well as on-chip.

Example 7B. The system of example 1B, wherein the instructions to apply the sub-function comprise instructions to apply a decomposition sub-function configured to receive the table of data and break the table of data into sub-tables, wherein the processing circuitry is configured to: store a minimum value of each sub-table as an element in a table T_{bias}; subtract the minimum value from all values in each corresponding sub-table and store the resulting values in table Tₛₜ.

Example 8B. The system of example 2B, wherein the programming instructions further comprise programming instructions to apply a self-similarities sub-function that includes programming instructions to compare the received tables of data from the decomposition sub-function and determine whether one or more secondary tables are generatable by a primary table.

Example 9B. The system of example 3B, wherein to apply a higher bit compression sub-function comprises to first split the received table into a first table of lower bits and second table of higher bits, then apply the decomposition sub-function to the first table of lower bits.

Example 10B. The system of example 4B, wherein to apply a multilevel compression sub-function comprises to first apply decomposition sub-function, resulting in T_{bias} and Tₛₜ, then applying the decomposition sub-function, the self-similarity sub-function and high bit compression sub-function one or more times to the resulting T_{bias} matrix, wherein T_{bias} is replaced by another set of T_{lb}, Tᵤₛₜ, T_{idx}, Tᵣₛₕ, and T_{bias}.

Example 11B. A method comprising: receiving, by processing circuitry operatively coupled to a memory; a table of data; applying, by the processing circuitry, one or more sub-functions to the received table of data, wherein the one or more sub-functions executed by the processing circuitry is configured to compress the received table of data; generating, based on the compressed and received table of data, a compressed table of data and storing the data in memory.

Example 12B. The method of claim 11B, wherein generating the compressed and received table of data comprises generating a hardware IP block in the form of a hardware description language for accessing the table of data.

Example 13B. The method of claim 11B, wherein to store the compressed table of data in memory comprises generating a series of memory blocks to be placed in memory of a processing unit accessed by software running on the processing unit using a series of array access instructions.

Example 14B. The system of claim 1B, wherein the memory is located on chip.

Example 15B. The system of claim 1B, wherein the memory is located off-chip.

Example 16B. The system of claim 1B, wherein the memory is located off-chip as well as on-chip.

Example 17B. The method of claim 11B, wherein applying the one or more sub-functions comprises applying, by the processing circuitry, a decomposition sub-function configured to receive the table of data and break the table of data into sub-tables; the method further comprising: storing a minimum value of each sub-table as an element in a table T_{bias}; subtracting the minimum value from all values in each corresponding sub-table and storing the resulting values in table Tₛₜ.

Example 18B. The method of claim 17B, wherein applying the one or more sub-functions comprises applying, by the processing circuitry a self-similarities sub-function, wherein the self-similarities sub-function comprises comparing, by the processing circuitry, the received tables of data from the decomposition sub-function and determine whether one or more secondary tables may be generated by a primary table.

Example 19B. The method of claim 18B, wherein applying a higher bit compression sub-function comprises: first, splitting the received table into a first table of lower bits and second table of higher bits, then applying the decomposition sub-function to the first table of lower bits.

Example 20B. The method of claim 19B, wherein applying, by the processing circuitry, a multilevel compression sub-function comprises: first applying, by the processing circuitry, the decomposition sub-function, resulting in T_{bias} and Tₛₜ, then applying, by the processing circuitry, the decomposition sub-function, the self-similarity sub-function and high bit compression sub-function one or more times to the resulting T_{bias} matrix, wherein, for each iteration, T_{bias} is replaced by another set of T_{lb}, Tᵤₛₜ, T_{idx}, Tᵣₛₕ, and T_{bias}.

Example 21B. A non-transitory computer-readable storage medium comprising instructions that, when executed, cause processing circuitry of a computing device to: receive a table of data; apply one or more sub-functions to a received table of data, wherein the one or more sub-functions executed by the processing circuitry is configured to compress the received table of data; generate, based on the compressed and received table of data, a compressed table of data and storing the compressed table of data in memory.

Example 22B. The non-transitory computer-readable storage medium of claim 21B, wherein the one or more sub-functions executed by the processing circuitry are configured to compress the received table of data and generate a hardware IP block in the form of a hardware description language for accessing the table of data.

Example 23B. The non-transitory computer-readable storage medium of claim 21B, wherein to store the compressed table of data in memory comprises to generate a series of memory blocks to be placed in memory of a processing unit accessed by software running on the processing unit using a series of array access instructions.

Example 24B. The non-transitory computer-readable storage medium of claim 21B, wherein the memory is located on chip.

Example 25B. The non-transitory computer-readable storage medium of claim 21B, wherein the memory is located off-chip.

Example 26B. The non-transitory computer-readable storage medium of claim 21B, wherein the memory is located off-chip as well as on-chip.

Example 27B. The non-transitory computer-readable storage medium of claim 11B, wherein the instructions to apply the sub-function comprise instructions to apply, by the processing circuitry, a decomposition sub-function configured to: receive the table of data and break the table of data into sub-tables; store a minimum value of each sub-table as an element in a table T_{bias}; subtract the minimum value from all values in each corresponding sub-table and store the resulting values in table Tₛₜ.

Example 28B. The non-transitory computer-readable storage medium of claim 27B, wherein the instructions further cause the processing circuitry to apply a self-similarities sub-function that includes programming instructions to compare the received tables of data from the decomposition sub-function and determine whether one or more secondary tables may be generated by a primary table.

Example 29B. The non-transitory computer-readable storage medium of claim 28B, wherein the instructions cause the processing circuitry to: apply a higher bit compression sub-function, wherein to apply the higher bit compression sub-function comprises: first, split the received table into a first table of lower bits and second table of higher bits, then apply the decomposition sub-function to the first table of lower bits.

Example 30B. The non-transitory computer-readable storage medium of claim 29B, wherein the instructions cause the processing circuitry to apply a multilevel compression sub-function comprises: first to apply, by the processing circuitry, the decomposition sub-function, resulting in T_{bias} and Tₛₜ, then apply the decomposition sub-function, the self-similarity sub-function and high bit compression sub-function one or more times to the resulting T_{bias} matrix, wherein, for each iteration, T_{bias} is replaced by another set of T_{lb}, Tᵤₛₜ, T_{idx}, Tᵣₛₕ, and T_{bias}.

In one or more examples, the functions described above may be implemented in hardware, software, firmware, or any combination thereof. For example, the various components of FIGS. 1, such as processing circuitry 120 and CPU 116 may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

The term “non-transitory” may indicate that the storage medium is not embodied in a carrier wave or a propagated signal. In certain examples, a non-transitory storage medium may store data that can, over time, change (e.g., in RAM or cache). By way of example, and not limitation, such computer-readable storage media, may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor” and “processing circuitry,” as used herein, such as CPU 116, may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. These and other examples are within the scope of the following claims.

What is claimed is:

1. A circuit to implement a function, the circuit comprising:
memory storing compressed sub-tables of a table of data;
an input circuit configured to receive an input address for the table of data; and
circuitry configured to:
retrieve values from the compressed sub-tables based on the input address; and
generate output data based on the retrieved values.

2. The circuit of claim 1, wherein the sub-tables are derived from the table of data.

3. The circuit of claim 2, wherein a subset of data from the table of data includes a self-similarities subset of data that includes programming instructions to compare received tables of data from a decomposition subset of data and determine whether one or more secondary tables are generable by a primary table.

4. The circuit of claim 3, wherein the programming instructions further comprise programming instructions to apply a higher bit compression subset of data, wherein to apply a higher bit compression subset of data comprises:
first split the received table into a first table of lower bits and second table of higher bits, then
apply the decomposition subset of data to the first table of lower bits.

5. The circuit of claim 1, wherein the sub-tables include at least one of:
T_{lb} that includes lower bits of the output data,
Tᵤₛₜ that includes unique sub-tables of the table of data,
T_{idx} that includes indices,
Tᵣₛₕ that includes right shift values, or
T_{bias} that includes a minimum value to be added as part of the output data.

6. The circuit of claim 5, wherein T_{bias} is derived from the table of data by finding the minimum value from each subset of data.

7. The circuit of claim 5, wherein the circuitry is further configured to:
concatenate an output of the sub-table T_{idx} with upper bits of the input address to select a unique sub-table from the sub-table Tᵤₛₜ.

8. The circuit of claim 7, wherein the circuitry is further configured to:
perform a right shift on a selected number of bits of the sub-table Tᵣₛₕ based in part on the upper bits of the input address.

9. The circuit of claim 7, wherein the circuitry further comprises:
an adder configured to add an output value of a table T_{bias} and an output value of a right shift or Tᵤₛₜ output.

10. The circuit of claim 1, wherein to generate the output data, the circuitry is further configured to concatenate lower bits of the input address with retrieved values from the compressed sub-tables.

11. A method, comprising:
receiving, by processing circuitry, a table of data;
retrieving, by the processing circuitry, values from compressed sub-tables of the table of data based on an input address, wherein the compressed sub-tables are stored in a memory; and
generating, by the processing circuitry, output data based on the retrieved values.

12. The method of claim 11, wherein the sub-tables are derived from the table of data.

13. The method of claim 12, wherein a subset of data from the table of data includes programming instructions to compare received tables of data from a decomposition subset of data and determine whether one or more secondary tables are generable by a primary table.

14. The method of claim 13, wherein the programming instructions further comprise of programming instructions to apply a higher bit compression subset of data, wherein to apply a higher bit compression subset of data comprises:
first split the received table into a first table of lower bits and a second table of higher bits, then
apply the decomposition subset of data to the first table of lower bits.

15. The method of claim 11, wherein the sub-tables include at least one of:
T_{lb} that includes lower bits of the input address,
Tᵤₛₜ that includes unique sub-tables of the table of data,
T_{idx} that includes an index
Tᵣₛₕ that includes right shift values or
T_{bias} that includes a minimum value of each sub-table as an element.

16. The method of claim 15, wherein T_{bias} is derived from the table of data by finding the minimum value from each subset of data.

17. The method of claim 15, further comprising:
concatenating, by the processing circuitry, an output of the sub-table T_{idx} with upper bits of the input address to select a unique sub-table from the sub-table Tᵤₛₜ.

18. The method of claim 17, further comprising:
performing, by the processing circuitry, a right shift on selected bits of a sub-table Tᵣₛₕ based in part on upper bits of the input address.

19. The method of claim 17, further comprising:
adding an output value of the table T_{bias} and an output value of a right shift or Tᵤₛₜ output.

20. Non-transitory computer-readable media, configured with instructions that, when executed, cause processing circuitry to:
receive an input address;
retrieve values from compressed sub-tables of the table of data based on the input address, wherein the compressed sub-tables are stored in a memory; and
generate output data based on the retrieved values.
